(19) United States
(12) Patent Application Publication
(10) Pub. No.: US 2017/0171333 A1
(43) Pub. Date: Jun. 15, 2017

(54) METHOD AND ELECTRONIC DEVICE FOR INFORMATION PUSHING

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Shengcai LIU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,257

(22) Filed: Aug. 19, 2016

Related U.S. Application Data
(63) Continuation of application No. PCT/CN2016/089549, filed on Jul. 10, 2016.

(30) Foreign Application Priority Data
Dec. 15, 2015 (CN) 201510937819.5

(51) Int. Cl. H04L 29/08

(52) U.S. Cl. CPC H04L 67/26; H04L 67/306; H04L 67/32

(57) ABSTRACT

Embodiments of the present disclosure relate to the communications field, and disclose an information pushing method and electronic device for information pushing. The method for information pushing includes: pushing information related to a scheduled event to a user; receiving feedback on the information from the user; and sending, according to the feedback from the user, a notification to the user within a predetermined time before the event occurs. By means of the embodiments of the present disclosure, the feedback on the information from the user can reflect whether the user is interested in a scheduled event such as a film, and thereby the user can be reminded again in a notification manner within a predetermined time before a release date of the film.

### CROSS-REFERENCE TO RELATED APPLICATIONS

The present disclosure is a continuation of PCT application No. PCT/CN2016/089549 submitted on Jul. 10, 2016, and claims priority to Chinese Patent Application No. 201510937819.5, filed with the Chinese Patent Office on Dec. 15, 2015, which is incorporated herein by reference in its entirety.

### TECHNICAL FIELD

The present disclosure relates to the communications field, and in particular, to a method and electronic device for information pushing.

### BACKGROUND

News of upcoming films is for providing a film playing schedule for a future period for audience.

Posters are a common used means for information provision, and are not merely a special sticker used for professional drama shows, but are gradually used for reporting or introducing messages about dramas, films, sports events, artistic performances, and public lectures to the public, and some posters are designed artistically. Posters possess a feature of being posted everywhere in screening or performance places and streets. Posters with artistic designing are picture posters for films, dramas, and sports. Information provided by film posters is also known as news of upcoming films. To publicize information better, posters are generally spread in public places such as streets, cinemas and theaters, exhibitions, commercial districts, stations, wharfs, and gardens.

Current news of upcoming films is presented by means of posters, and if an audience does not notice a poster, the audience is quite likely to miss a film. With development of Internet technologies, electronic posters emerge to push information to people more quickly. However, the electronic posters still have the same problem as traditional posters.

A solution is not provided for the foregoing problem in the prior art.

### SUMMARY

An objective of this present disclosure is to provide a method and an electronic device, to avoid missing information, the method and electronic device can targetedly push information to a user.

To achieve the foregoing objective, embodiments of the present disclosure provide a method for information pushing, where the method includes: pushing information related to a scheduled event to a user; receiving feedback on the information from the user; and sending, according to the feedback from the user, a notification to the user within a predetermined time before the event occurs.

An embodiment of this disclosure further provides a non-volatile computer storage medium, which stores computer executable instructions, where the computer executable instructions are used to execute any foregoing method for information pushing of this disclosure.

An embodiment of this disclosure further provides an electronic device, including: at least one processor; and a memory communicably connected with the at least one processor for storing instructions executable by the at least one processor, where execution of the instructions by the at least one processor causes the at least one processor to execute any foregoing method for information pushing of this disclosure.

Other features and advantages of the present disclosure are described in detail in the description of embodiments section below.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation. In the accompanying drawings:

FIG. 1 is a flowchart of a method for information pushing according to an implementation manner of the present disclosure: and

FIG. 2 is a schematic structural diagram of hardware of an electronic device for executing a method for information pushing provided in an implementation manner of this disclosure.

### DETAILED DESCRIPTION

Specific implementation manners of embodiments of the present disclosure are described in detail below with reference to the accompanying drawings. It is to be understood that, the specific implementation manners described herein are intended only to describe and explain the embodiments of the present disclosure, but not to limit the embodiments of the present disclosure.

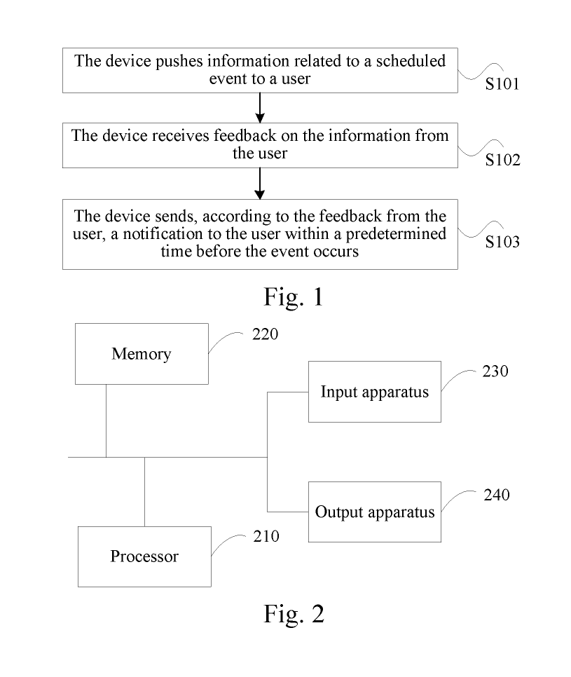

FIG. 1 is a flowchart of a method for information pushing according to an implementation manner of the present disclosure. As shown in FIG. 1, a method for information pushing is provided in the implementation manner of the present disclosure, where the method may include: in Step S101, the device pushes information related to a scheduled event to a user; in Step S102, the device receives feedback on the information from the user; and in Step S103, the device sends, according to the feedback from the user, a notification to the user within a predetermined time before the event occurs.

By means of the foregoing technical solution, the feedback on the information from the user can reflect whether a user is interested in such as a film scheduled event, and thereby the user can be reminded again in a notification manner within a predetermined time before a release date of the film.

In an implementation manner, information may be pushed to the user according to interests and preferences of the user. In the foregoing implementation manner, for example, the information is news of upcoming films, and the event is film release. In such an implementation manner, the foregoing method may further include: acquiring an event type, for example, a film type, in which the user is interested in; and pushing information related to the event type in which the user is interested in, for example, news of upcoming films or release information related the interested film type, to the user. In an implementation manner, interests and preferences of the user may be acquired by receiving a keyword input by the user and/or feedback from the user, and an event type related to the keyword and/or the feedback is determined as same as the event type, for example, the film type, in which the user is interested in. Film types are different types of films classified according to different themes or techniques, for example, police and gangster/crime films, disaster films, action/adventure films, horror/thriller films, suspense films, romance films, comedies, western films, and music and dance films. The user may first select film types in which the user is interested in, and thereby can acquire release information of films in which the user may be interested in, and then the user may select, from the films in which the user may be interested in, a film in which the user is interested in for feedback.

In an implementation manner, the feedback from the user may be one of collecting the information or reserving the event. Specifically, the user may login an information pushing system by using a username and a password of the user, and select film types or film keywords in which the user is interested in the system. When a new film is to be released, and the film satisfies a film type or keyword selected by the user, the system pushes information related to an introduction or a release date of the new film to the user. The user may feedback to the system whether the user is interested in the information. For example, the feedback of the user may reflect whether the user is interested in such as the film scheduled event. Thereby the system may remind, according to the feedback of the user, the user again may be reminded in a notification manner within a predetermined time (for example, a week, a day, or three days) before the release date of the film. In this implementation manner, in the foregoing method, the system may push, in response to a positive response to the notification from the user, the event to the user when the event occurs.

Another aspect of the embodiments of the present disclosure provides a device for information pushing, where the device includes: a device configured to push information related to a scheduled event to a user; a device configured to receive feedback on the information from the user; and a device configured to send, according to the feedback from the user, a notification to the user within a predetermined time before the event occurs.

In an implementation manner, the device may further include a device configured to, in response to a positive response to the notification from the user, push the event to the user when the event occurs.

In an implementation manner, the feedback from the user may be one of collecting the information or reserving the event.

In an implementation manner, the device may further include a device configured to acquire an event type in which the user is interested; and a device configured to push information related to the event type in which the user is interested into the user.

In an implementation manner, the information is news of upcoming films, and the event is a film release.

In an implementation manner, the device may further include: a device configured to receive a keyword input by the user and/or feedback from the user; and a device configured to determine an event type related to the keyword and/or the feedback is the event type in which the user is interested in.

In an implementation manner, the device for information pushing provided in the implementation manners of the present disclosure may be a wireless transmitting/receiving device, and may communicate with an information providing server in a wireless/wired manner to acquire the information related to the scheduled event, and may present the information to the user.

By means of the foregoing technical solution, the feedback on the information from the user can reflect whether the user is interested in a scheduled event such as a film, and thereby the user can be reminded again in a notification manner within a predetermined time before a release date of the film.

An implementation manner of this disclosure further provides a non-volatile computer storage medium, which stores computer executable instructions, where the computer executable instructions can execute the method for information pushing in any foregoing method embodiment.

FIG. 2 is a schematic structural diagram of hardware of an electronic device for executing the method for information pushing provided in an embodiment of this disclosure. As shown in FIG. 2, the electronic device includes:

one or more processors 210 and a memory 220, where only one processor 210 is used as an example in FIG. 2.

The device for executing the method for information pushing may further include: an input apparatus 230 and an output apparatus 240.

The processor 210, the memory 220, the input device 230, and the output device 240 can be connected by means of a bus or in other manners. A connection by means of a bus is used as an example in FIG. 2.

As a non-volatile computer readable storage medium, the memory 220 can be used to store non-volatile software programs, non-volatile computer executable programs and modules, for example, program instructions/module corresponding to the method for information pushing in the embodiments of this disclosure. The processor 210 executes various functional applications and data processing of the server, that is, implements the method for information pushing of the foregoing method embodiments, by running the non-volatile software programs, instructions, and modules that are stored in the memory 220.

The memory 220 may include a program storage area and a data storage area, where the program storage area may store an operating system and an application that is needed by at least one function; the data storage area may store data created according to use of the device for information pushing, and the like. In addition, the memory 220 may include a high-speed random access memory, or may also include a non-volatile memory such as at least one disk storage device, flash storage device, or another non-volatile solid-state storage device. In some embodiments, the memory 220 optionally includes memories that are remotely disposed with respect to the processor 210, and the remote memories may be connected, via a network, to the electronic device. Examples of the foregoing network include but are not limited to: the Internet, an intranet, a local area network, a mobile communications network, or a combination thereof.

The input apparatus 230 can receive entered digits or character information, and generate key signal inputs relevant to user setting and functional control of the electronic device. The output apparatus 240 may include a display device, for example, a display screen.

The one or more modules are stored in the memory 220; when the one or more modules are executed by the one or more processors 210, the method for information pushing in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic device having a data interaction function.

The device embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. A method for information pushing, applied to an electronic device, comprising:
pushing information related to a scheduled event to a user;
receiving feedback on the information from the user; and
sending, according to the feedback from the user, a notification to the user within a predetermined time before the event occurs.

2. The method according to claim 1, wherein the method further comprises:
in response to a positive response to the notification from the user, pushing the event to the user when the event occurs.

3. The method according to claim 1, wherein the feedback from the user is one of collecting the information or reserving the event.

4. The method according to claim 1, wherein the method further comprises:
acquiring an event type in which the user is interested in; and
pushing information related to the event type in which the user is interested in to the user.

5. The method according to claim 4, wherein the step of acquiring an event type in which the user is interested in comprises:
receiving a keyword input by the user and/or feedback from the user; and
determining an event type related to the keyword and/or the feedback as the event type in which the user is interested in.

6. A non-volatile computer storage medium, which stores computer executable instructions that, when executed by an electronic device, cause the electronic device to:
push information related to a scheduled event to a user;
receive feedback on the information from the user; and
send, according to the feedback from the user, a notification to the user within a predetermined time before the event occurs.

7. The non-volatile computer storage medium according to claim 6, wherein the computer executable instructions are further set to:
in response to a positive response to the notification from the user, push the event to the user when the event occurs.

8. The non-volatile computer storage medium according to claim 6, wherein the feedback from the user is one of collecting the information or reserving the event.

9. The non-volatile computer storage medium according to claim 6, wherein the computer executable instructions are further set to:
acquire an event type in which the user is interested; and
push information related to the event type in which the user is interested to the user.

10. The non-volatile computer storage medium according to claim 9, wherein the instructions to acquire an event type in which the user is interested cause the electronic device to:
receive a keyword input by the user and/or feedback of the user; and
determine an event type related to the keyword and/or the feedback as the event type in which the user is interested.

11. An electronic device, comprising:
at least one processor; and
a memory communicably communication with the at least one processor, wherein
the memory stores instructions executable by the at least one processor, wherein
execution of the instructions by the at least one processor causes the at least one processor to:
push information related to a scheduled event to a user;
receive feedback on the information from the user; and
send, according to the feedback from the user, a notification to the user within a predetermined time before the event occurs.

12. The electronic device according to claim 11, wherein the instructions are configured to:
in response to a positive response to the notification from the user, push the event to the user when the event occurs.

13. The electronic device according to claim 11, wherein the feedback from the user is one of collecting the information or reserving the event.

14. The electronic device according to claim 11, wherein the instructions are configured to:
acquire an event type in which the user is interested; and
push information related to the event type in which the user is interested to the user.

15. The electronic device according to claim 14, wherein to acquire an event type in which the user is interested the instructions are configured to:
receive a keyword input by the user and/or feedback of the user; and
determine an event type related to the keyword and/or the feedback as the event type in which the user is interested.
